(19) United States
(12) Patent Application Publication
(10) Pub. No.: US 2026/0132085 A1
(43) Pub. Date: May 14, 2026

(54) CORDIERITE SINTERED BODY AND METHOD FOR PRODUCING SAME

(71) Applicants: AGC INC., Tokyo (JP); AGC CERAMICS CO., LTD., Tokyo (JP)

(72) Inventors: Shuhei OGAWA, Tokyo (JP); Naomichi MIYAKAWA, Tokyo (JP); Takuya UMEZOME, Tokyo (JP); Saori INOUE, Tokyo (JP)

(73) Assignees: AGC INC., Tokyo (JP); AGC CERAMICS CO., LTD., Tokyo (JP)

(21) Appl. No.: 19/445,740

(22) Filed: Jan. 12, 2026

Related U.S. Application Data
(63) Continuation of application No. PCT/JP2024/025281, filed on Jul. 12, 2024.

(30) Foreign Application Priority Data
Jul. 19, 2023 (JP) 2023-117542

(51) Int. Cl. C04B 35/195; C04B 35/64

(52) U.S. Cl. CPC C04B 35/195; C04B 35/64; C04B 2235/3206; C04B 2235/3225; C04B 2235/3418; C04B 2235/3481; C04B 2235/9607

(57) ABSTRACT

Provided is a cordierite sintered body including at least calcium, magnesium, aluminum, and silicon among elements belonging to an element group M1 consisting of calcium, magnesium, aluminum, yttrium, and silicon, in which a content of silicon is 44.0 mass % or more and 53.0 mass % or less in terms of oxides, a content of calcium is 2.0 mass % or less in terms of oxides, a content of yttrium is 7.0 mass % or less in terms of oxides, a content of an element M2 including a metal element other than the elements belonging to the element group M1 is 2.5 mass % or less in terms of oxides, and a dielectric loss tangent at 20 GHz is 0.00100 or less.

### CROSS-REFERENCE TO RELATED APPLICATIONS

This is a bypass continuation of International Application No. PCT/JP2024/025281 filed on Jul. 12, 2024, and claims priority from Japanese Patent Application No. 2023-117542 filed on Jul. 19, 2023, the entire content of which is incorporated herein by reference.

### TECHNICAL FIELD

The present invention relates to a cordierite sintered body and a method for producing the same.

### BACKGROUND ART

In the related art, a sintered body containing cordierite (cordierite sintered body) has been used as, for example, a member to be exposed to plasma (Patent Literature 1).

### CITATION LIST

### Patent Literature

Patent Literature 1: JPH09-295863A

### SUMMARY OF INVENTION

### Technical Problem

In recent years, the use of a cordierite sintered body in various fields has been studied, and the development of a novel cordierite sintered body having properties different from known properties has been desired.

The present invention has been made in view of the above points, and an object thereof is to provide a novel cordierite sintered body and a method for producing the same.

### Solution to Problem

As a result of intensive studies, the inventors of the present invention have found that the above object can be achieved by adopting the following configurations, and have completed the present invention.

That is, the present invention provides the following [1] to [15].

[1] A cordierite sintered body including at least calcium, magnesium, aluminum, and silicon among elements belonging to an element group M1 consisting of calcium, magnesium, aluminum, yttrium, and silicon, in which
a content of silicon is 44.0 mass % or more and 53.0 mass % or less in terms of oxides,
a content of calcium is 2.0 mass % or less in terms of oxides,
a content of yttrium is 7.0 mass % or less in terms of oxides,
a content of an element M2 including a metal element other than the elements
belonging to the element group M1 is 2.5 mass % or less in terms of oxides, and a dielectric loss tangent at 20 GHz is 0.00100 or less.

[2] The cordierite sintered body according to the above [1], in which a content of magnesium is 15.0 mass % or less in terms of oxides.

[3] The cordierite sintered body according to the above [1] or [2], having a Weibull coefficient of 9.0 or more.

[4] The cordierite sintered body according to any one of the above [1] to [3], in which a content of iron is 2000 ppm by mass or less in terms of oxides.

[5] The cordierite sintered body according to any one of the above [1] to [4], in which the content of calcium is 1.0 mass % or less in terms of oxides.

[6] The cordierite sintered body according to any one of the above [1] to [5], in which a content of aluminum is 33.0 mass % or more in terms of oxides.

[7] The cordierite sintered body according to any one of the above [1] to [6], having a relative dielectric constant at 20 GHz of 4.80 or more.

[8] The cordierite sintered body according to any one of the above [1] to [7], in which a total content of sodium, potassium, strontium, titanium, phosphorus, chromium, manganese, iron, nickel, lanthanum, gallium, zirconium, zinc, and niobium is 3000 ppm by mass or less in terms of oxides.

[9] The cordierite sintered body according to any one of the above [1] to [8], in which a total content of chromium, manganese, iron, and nickel is 1000 ppm by mass or less in terms of oxides.

[10] The cordierite sintered body according to any one of the above [1] to [9], having a thermal conductivity of 3.0 W/(m·K) or more.

[11] The cordierite sintered body according to any one of the above [1] to [10], in which a number of foreign particles containing the element M2 and having an equivalent circle diameter of 5 μm or more is 150/cm² or less.

[12] The cordierite sintered body according to any one of the above [1] to [11], in which the content of yttrium is 0.2 mass % or more in terms of oxides.

[13] The cordierite sintered body according to any one of the above [1] to [12], having a 4-point bending strength of 170 MPa or more.

[14] A method for producing the cordierite sintered body according to any one of the above [1] to [13], the method including:
preparing a molded body using a raw material powder; and
heating the molded body, in which
as the raw material powder, a mixed powder containing a cordierite powder produced by an electric fusion method, a mullite powder, and a magnesium oxide powder is used.

[15] The method for producing the cordierite sintered body according to the above [14], in which the cordierite powder is subjected to magnetic separation before use.

### Advantageous Effects of Invention

According to the present invention, there is provided a novel cordierite sintered body and a method for producing the same.

### DESCRIPTION OF EMBODIMENTS

The terms used in the present description have the following meanings. A numerical range represented by using “to” means a range including numerical values described before and after “to” as a lower limit value and an upper limit value.

### [Cordierite Sintered Body]

A cordierite sintered body according to the present embodiment contains at least calcium, magnesium, aluminum, and silicon among elements belonging to an element group M1 consisting of calcium, magnesium, aluminum, yttrium, and silicon. A content of silicon is 44.0 mass % or more and 53.0 mass % or less in terms of oxides. A content of calcium is 2.0 mass % or less in terms of oxides. A content of yttrium is 7.0 mass % or less in terms of oxides. A content of an element M2, which is a metal element other than the elements belonging to the element group M1, is 2.5 mass % or less in terms of oxides. A dielectric loss tangent at 20 GHz is 0.00100 or less.

Hereinafter, the cordierite sintered body is simply referred to as a “sintered body”, and the cordierite sintered body according to the present embodiment may be referred to as “the present sintered body”.

The present sintered body is a sintered body of metal oxides containing cordierite.

A chemical formula representing the cordierite includes, for example, 2MgO·2Al₂O₃·5SiO₂, but is not limited thereto.

The present sintered body contains calcium (Ca) in addition to the cordierite (2MgO·2Al₂O₃·5SiO₂), and the content thereof is small. Further, the present sintered body has a small content of a metal element (element M2 to be described later) other than Ca, magnesium (Mg), and the like.

The present sintered body has a small dielectric loss tangent at 20 GHz.

Hereinafter, the present sintered body will be described in more detail.

Note that, hereinafter, the dielectric loss tangent at 20 GHz and the dielectric loss tangent at 10 GHz are collectively and simply referred to as “dielectric loss tangent”.

### <Element Group M1>

An element group consisting of calcium (Ca), magnesium (Mg), aluminum (Al), yttrium (Y), and silicon (Si) is referred to as “element group M1”.

As described above, the present sintered body contains Ca in addition to the cordierite (2MgO·2Al₂O₃·5SiO₂).

Therefore, the present sintered body contains at least Ca, Mg, Al, and Si among the elements belonging to the element group M1.

### <<Ca>>

The content of Ca is 2.0 mass % or less, preferably 1.0 mass % or less, more preferably 0.7 mass % or less, still more preferably 0.4 mass % or less, even more preferably 0.2 mass % or less, particularly preferably 0.15 mass % or less, more particularly preferably 0.1 mass % or less, very preferably 0.05 mass % or less, and most preferably 0.01 mass % or less since the dielectric loss tangent of the present sintered body is reduced.

On the other hand, the content of Ca is more than 0 mass %, preferably 0.02 mass % or more, and more preferably 0.05 mass % or more in terms of oxides, from the viewpoint of mass production cost and raw material procurement.

The content of Ca in terms of oxides specifically refers to a content of CaO.

### <<Mg>>

The content of Mg is preferably 15.0 mass % or less, more preferably 14.5 mass % or less, still more preferably 14.0 mass % or less, particularly preferably 13.5 mass % or less, and most preferably 13.0 mass % or less in terms of oxides since the dielectric loss tangent of the present sintered body is reduced.

On the other hand, the content of Mg is preferably 11.0 mass % or more, more preferably 12.0 mass % or more, and still more preferably 12.5 mass % or more in terms of oxides.

The content of Mg in terms of oxides specifically refers to a content of MgO.

### <<Al>>

The content of Al is preferably 33.0 mass % or more, more preferably 34.0 mass % or more, still more preferably 35.0 mass % or more, and particularly preferably 36.0 mass % or more in terms of oxides since the present sintered body has an excellent balance between the dielectric loss tangent and the strength.

The content of Al is preferably 40.0 mass % or less, more preferably 39.0 mass % or less, and still more preferably 38.0 mass % or less in terms of oxides for the same reason.

The content of Al in terms of oxides specifically refers to a content of Al₂O₃.

### <<Si>>

In the present sintered body, the content of Si is 44.0 mass % or more and 53.0 mass % or less in terms of oxides.

The content of Si is 53.0 mass % or less, preferably 51.0 mass % or less, more preferably 50.0 mass % or less, still more preferably 49.0 mass % or less, particularly preferably 48.5 mass % or less, and most preferably 48.0 mass % or less in terms of oxides since the dielectric loss tangent of the present sintered body is reduced.

On the other hand, the content of Si is 44.0 mass % or more, preferably 45.0 mass % or more, and more preferably 46.0 mass % or more in terms of oxides.

The content of Si in terms of oxides specifically refers to a content of SiO₂.

### <<Y>>

In the present sintered body, the content of Y may be 0 mass %.

However, the present sintered body preferably contains Y since the 4-point bending strength is increased. Specifically, the content of Y is preferably 0.2 mass % or more, more preferably 1.0 mass % or more, still more preferably 1.5 mass % or more, particularly preferably 2.0 mass % or more, very preferably 2.5 mass % or more, and most preferably 3.0 mass % or more in terms of oxides.

However, when the content of Y is too large, the 4-point bending strength decreases. Therefore, the content of Y is 7.0 mass % or less in terms of oxides. The content of Y is preferably 6.0 mass % or less, more preferably 5.0 mass % or less, and still more preferably 4.0 mass % or less in terms of oxides since the 4-point bending strength of the present sintered body is increased.

The content of Y in terms of oxides specifically refers to a content of Y₂O₃.

### <Element M2>

In the present sintered body, the content of the element M2, which is a metal element other than those in the above element group M1, is small. Accordingly, the present sintered body has a low dielectric loss tangent.

Specifically, the content of the element M2 is 2.5 mass % or less, preferably 2.0 mass % or less, more preferably 1.0 mass % or less, still more preferably 0.5 mass % or less, even more preferably 0.3 mass % or less, particularly preferably 0.2 mass % or less, very preferably 0.15 mass % or less, and most preferably 0.1 mass % or less, in terms of oxides. The lower limit value is preferably zero.

Examples of the element M2 include at least one element selected from the group consisting of sodium (Na), potassium (K), strontium (Sr), titanium (Ti), phosphorus (P), chromium (Cr), manganese (Mn), iron (Fe), nickel (Ni), lanthanum (La), gallium (Ga), zirconium (Zr), zinc (Zn), and niobium (Nb).

The total content of Na, K, Sr, Ti, P, Cr, Mn, Fe, Ni, La, Ga, Zr, Zn, and Nb in terms of oxides is preferably 3000 ppm by mass or less (0.3 mass % or less), more preferably 2100 ppm by mass or less, still more preferably 1600 ppm by mass or less, even more preferably 1200 ppm by mass or less, particularly preferably 800 ppm by mass or less, and most preferably 400 ppm by mass or less, since the dielectric loss tangent of the present sintered body is reduced.

Note that, although P is not a metal element, it is considered as a metal element when treated as the element M2.

A content of Na in terms of oxides specifically refers to a content of Na₂O.

A content of K in terms of oxides specifically refers to a content of K₂O.

A content of Sr in terms of oxides specifically refers to a content of SrO.

A content of Ti in terms of oxides specifically refers to a content of TiO₂.

A content of P in terms of oxides specifically refers to a content of P₂O₅.

A content of Cr in terms of oxides specifically refers to a content of Cr₂O₃.

A content of Mn in terms of oxides specifically refers to a content of MnO.

A content of Fe in terms of oxides specifically refers to a content of Fe₂O₃.

A content of Ni in terms of oxides specifically refers to a content of NiO.

A content of La in terms of oxides specifically refers to a content of La₂O₃.

A content of Ga in terms of oxides specifically refers to a content of Ga₂O₃.

A content of Zr in terms of oxides specifically refers to a content of ZrO₂.

A content of Zn in terms of oxides specifically refers to a content of ZnO.

A content of Nb in terms of oxides specifically refers to a content of Nb₂O₅.

### <<Fe>>

A content of Fe is preferably 2000 ppm by mass (0.2 mass %) or less, more preferably 1000 ppm by mass or less, still more preferably 500 ppm by mass or less, even more preferably 300 ppm by mass or less, particularly preferably 200 ppm by mass or less, very preferably 150 ppm by mass or less, and most preferably 100 ppm by mass or less in terms of oxides, since the dielectric loss tangent is reduced and a heterogeneous phase amount is reduced in the present sintered body.

### <<Cr, Mn, Fe, and Ni>>

A total content of Cr, Mn, Fe, and Ni is preferably 1000 ppm by mass or less (0.1 mass % or less), more preferably 800 ppm by mass or less, still more preferably 600 ppm by mass or less, even more preferably 400 ppm by mass or less, very preferably 350 ppm by mass or less, particularly preferably 200 ppm by mass or less, and most preferably 100 ppm by mass or less in terms of oxides, since the heterogeneous phase amount of the present sintered body is reduced.

The contents of the metal elements (the element group M1 and the element M2, excluding Si) in the sintered body are measured using inductively coupled plasma mass spectrometry (ICP-MS).

Specifically, a sample is immersed in an extraction liquid of HF:HNO₃=4:1 (mass ratio) for 2 days and then heated at 80° C. for 1 hour. Thereafter, the sample is taken out using tweezers to obtain an extract in which the metal elements are extracted from the sample. The extract is dried and then the volume is adjusted to 10 mL using a HNO₃ solution, followed by analysis using an apparatus (Agilent 8800) manufactured by Agilent Technologies Inc.

The content of Si in the sintered body is determined as follows.

First, a powder sample is taken from a center of the sintered body by grinding, and a total oxygen amount Z1 in the sintered body is determined by an infrared absorption method using an oxygen/hydrogen analyzer (ROH-600 manufactured by LECO Corporation).

An oxygen amount Z3 is calculated by subtracting an oxygen amount Z2 bound to the elements (excluding silicon atoms) contained in the sintered body in the stoichiometric composition from the total oxygen amount Z1 in the sintered body (oxygen amount Z3=total oxygen amount Z1−oxygen amount Z2).

Assuming that the entire oxygen amount Z3 has been used for bonding with silicon atoms, the oxygen amount Z3 is converted to an amount of SiO₂. The amount in terms of SiO₂ thus obtained is defined as the content of Si in terms of oxides (content of SiO₂) in the sintered body.

### <Dielectric Loss Tangent>

The present sintered body has a dielectric loss tangent at 20 GHz of 0.00100 or less, preferably 0.00080 or less, more preferably 0.00060 or less, still more preferably 0.00050 or less, particularly preferably 0.00040 or less, and most preferably 0.00035 or less.

Similarly, the present sintered body preferably has a dielectric loss tangent at 10 GHz of 0.00100 or less, more preferably 0.00080 or less, still more preferably 0.00060 or less, even more preferably 0.00050 or less, particularly preferably 0.00040 or less, and most preferably 0.00035 or less.

The lower limit value is not particularly limited, and both the dielectric loss tangent at 20 GHz and the dielectric loss tangent at 10 GHz are, for example, 0.00010, and preferably 0.00020.

The dielectric loss tangent is a value measured at a frequency of 20 GHz or 10 GHz in an environment within a range of 23° C.±2° C. and 50±5% RH by using a SPDR (split post dielectric resonator) method.

Note that, in the case of measuring the dielectric loss tangent by applying an alternating electric field to a dielectric, an energy loss tends to increase as the frequency during the measurement increases. Therefore, in general, the dielectric loss tangent increases as the frequency increases, and conversely, the dielectric loss tangent decreases as the frequency decreases.

### <Relative Dielectric Constant>

The present sintered body preferably has a relative dielectric constant at 20 GHz (hereinafter, also simply referred to as a “relative dielectric constant”) of 4.80 or more, more preferably 4.82 or more, still more preferably 4.85 or more, and even more preferably 4.90 or more.

The upper limit is not particularly limited, and is, for example, 5.20, and preferably 5.10.

The relative dielectric constant is a value measured at a frequency of 20 GHz in an environment within a range of 23° C.±2° C. and 50±5% RH by using a SPDR (split post dielectric resonator) method.

### <Porosity>

The present sintered body has a porosity of preferably 3.0 vol % or less, more preferably 1.5 vol % or less, still more preferably 0.5 vol % or less, particularly preferably 0.2 vol % or less, very preferably 0.15 vol % or less, and most preferably 0.1 vol % or less. The lower limit value is preferably zero.

The porosity is determined according to the open porosity calculation method described in JIS R 1634:1998 “Method for measuring sintered body density and apparent porosity of fine ceramics”.

In order to keep the porosity within the above range, it is preferable to set the content of each component as described above and to produce the sintered body by a method to be described later (the present production method).

In particular, cordierite powder produced by an electric fusion method is preferably used as a raw material powder.

### <4-Point Bending Strength>

The present sintered body preferably has 4-point bending strength of 170 MPa or more, more preferably 180 MPa or more, still more preferably 190 MPa or more, and particularly preferably 200 MPa or more.

The upper limit is not particularly limited, and the 4-point bending strength of the present sintered body is, for example, 300 MPa or less, and may be 250 MPa or less.

The 4-point bending strength is measured at 25° C. on a sintered body test piece (flat plate, length: 50 mm, width: 4 mm, thickness: 3 mm) according to JIS R 1601 (2008).

In order to keep the 4-point bending strength within the above range, it is preferable to set the content of each component as described above and to produce the sintered body by the method to be described later (the present production method).

### <Weibull Coefficient>

The present sintered body preferably has a Weibull coefficient of 9.0 or more, more preferably 10.0 or more, more preferably 10.5 or more, still more preferably 11.0 or more, even more preferably 11.5 or more, particularly preferably 12.0 or more, more particularly preferably 12.2 or more, and most preferably 12.5 or more.

The upper limit is not particularly limited, and the Weibull coefficient of the present sintered body is, for example, 14.0 or less, and may be 13.0 or less.

The Weibull coefficient (Weibull coefficient of 4-point bending strength) is an index indicating the degree of a variation in 4-point bending strength, and the larger the value, the smaller the variation in 4-point bending strength.

The Weibull coefficient is determined as follows. First, the 4-point bending strength of 30 test pieces is measured by the method described above. Next, the Weibull coefficient is calculated according to JIS R 1625 (2010) using the 30 measured bending strength data.

In order to keep the Weibull coefficient within the above range, it is preferable to set the content of each component as described above and to produce the sintered body by the method to be described later (the present production method).

### <Thermal Conductivity>

The present sintered body has a thermal conductivity of preferably 3.0 W/(m·K) or more, more preferably 3.4 W/(m·K) or more, still more preferably 3.5 W/(m·K) or more, even more preferably 3.8 W/(m·K) or more, and particularly preferably 4.0 W/(m·K) or more.

The upper limit is not particularly limited, and the thermal conductivity of the present sintered body is, for example, 6.0 W/(m·K) or less, and may be 5.5 W/(m·K) or less.

The thermal conductivity is measured under a condition of 21° C. using a laser flash method thermophysical property measuring device “Xenon Flash Analyzer LFA 467 HyperFlash”, manufactured by NETZSCH, on a sintered body test piece (plate with 12 mm×12 mm, thickness: 6.0 mm).

In order to keep the thermal conductivity within the above range, it is preferable to set the content of each component as described above and to produce the sintered body by the method to be described later (the present production method).

### <Heterogeneous Phase Amount (Number of Foreign Particles)>

The sintered body is observed using a scanning electron microscope (SEM) at a magnification of 1,000 times to obtain SEM images of any 50 fields of view.

Foreign particles containing the element M2 (particles composed of the element M2) are identified in the obtained SEM images using an EDX (energy dispersive X-ray spectroscopy) device attached to the SEM. Among specified foreign particles, the number of foreign particles having an equivalent circle diameter of 5 μm or more (unit: particles/cm²) is measured, and the average value in 50 fields of view is determined. The equivalent circle diameter is determined by importing each captured SEM image into an image processing software (WinROOF (manufactured by MITANI CORPORATION), performing binarization processing, and determining the equivalent circle diameter of each foreign particle specified in advance. The average value of the determined number of foreign particles is defined as the number of foreign particles in the sintered body (this is referred to as a “heterogeneous phase amount” for convenience).

The heterogeneous phase amount of the present sintered body is preferably 150/cm² or less, more preferably 100/cm² or less, still more preferably 50/cm² or less, particularly preferably 30/cm² or less, and most preferably 10/cm² or less. The lower limit value is preferably zero.

In order to keep the heterogeneous phase amount within the above range, it is preferable to set the content of each component as described above and to produce the sintered body by the method to be described later (the present production method).

### <Shape and Use>

The shape of the present sintered body may be a plate shape (for example, a disk shape, a flat plate shape), a spherical shape, a spheroidal shape, or the like, and is appropriately selected according to the use.

Since the present sintered body has a small dielectric loss tangent, the present sintered body is suitably used as a dielectric having a small energy loss in, for example, the technical field in which high-frequency electromagnetic waves are used.

### [Method for Producing Cordierite Sintered Body]

Next, a method for producing the present sintered body (hereinafter, also referred to as “the present production method”) will be described.

The present production method is, roughly speaking, a method of preparing a molded body using a raw material powder and heating the molded body.

Hereinafter, the present production method will be described in detail.

### <Raw Material Powder>

As the raw material powder, a mixed powder containing a cordierite powder produced by an electric fusion method, a mullite powder, and a magnesium oxide powder is used.

As the raw material powder, a commercially available product can be appropriately used.

### <<Cordierite Powder>>

The cordierite (2MgO·2Al₂O₃·5SiO₂) powder is a raw material containing Mg, Al, and Si constituting the present sintered body.

Further, the cordierite powder may contain Ca as an impunity, and in this case, Ca constituting the present sintered body is supplied. By using the cordierite powder having a high purity, the content of Ca in the sintered body can be reduced.

### (Electrically Fused Cordierite Powder)

In the present production method, a cordierite powder produced by an electric fusion method (also referred to as an “electrically fused cordierite powder” for convenience) is used.

A method for obtaining the electrically fused cordierite powder is schematically as follows, for example.

First, a raw material of the electrically fused cordierite powder is charged into a crucible. Examples of the raw material of the electrically fused cordierite powder include magnesium oxide (MgO), aluminum oxide (Al₂O₃), and silica (SiO₂). These raw materials may contain impurities such as Ca.

Next, the raw material in the crucible is melted by generating plasma using, for example, a carbon electrode.

Thereafter, the molten raw material is air-pulverized and quenched.

Accordingly, an electrically fused cordierite powder is obtained. The electrically fused cordierite powder is a substance (powder) that is mainly amorphous and contains some crystals. Particles constituting the electrically fused cordierite powder are spherical and uniform in particle size. That is, they are homogeneous.

Therefore, the electrically fused cordierite powder is easily sintered in the presence of a mullite powder as a sintering aid, which is to be described later. That is, sinterability is good. As a result, a dense sintered body can be obtained and the porosity can be reduced. Further, impurities can be reduced by production using the electric fusion method.

### <<Mullite Powder>>

Mullite is represented by chemical formulae such as 3Al₂O₃·2SiO₂ and 2Al₂O₃·SiO₂. The mullite powder is used as a sintering aid. By using the mullite powder as a sintering aid, a dense sintered body can be obtained.

The mullite powder is a raw material containing Al and Si constituting the present sintered body.

### <<Magnesium Oxide Powder>>

The magnesium oxide (MgO) powder is a raw material containing Mg constituting the present sintered body.

### <<Yttrium Oxide Powder>>

In the case where the present sintered body contains Y, a yttrium oxide (Y₂O₃) powder is further used as a sintering aid. The yttrium oxide powder is a raw material containing Y constituting the present sintered body.

### <<Magnetic Separation>>

Each powder used as the raw material powder is preferably subjected to magnetic separation before use.

Accordingly, in the present sintered body finally obtained, the content of the element M2 (such as Fe), which is a metal element other than the metal elements (Ca, Mg, Al, Y, and Si) in the element group M1, can be reduced.

As a magnetic separation method, for example, a method using a wet magnetic filter can be preferably used. The magnetic separation conditions are not particularly limited, and may be appropriately adjusted, for example, such that the present sintered body obtained has a desired content of the element M2.

### <<Preparation of Raw Material Powder>>

The powders described above are subjected to magnetic separation, if necessary, and then mixed. Accordingly, a raw material powder, which is a mixed powder of respective powders, is obtained. The mixing method is not particularly limited, and known methods can be employed.

The content of each powder in the raw material powder (mixed powder) is appropriately adjusted such that the content of each component in the present sintered body finally obtained is a desired amount.

The mixed powder is preferably pulverized to reduce the particle size from the viewpoint of improving the sinterability during heating, which is to be described later. Specifically, the particle size of the mixed powder after pulverization is preferably 10 μm or less, and more preferably 2 μm or less. The particle size is a particle size (D₅₀) at an integrated value of 50% in a particle size distribution determined by using a laser diffraction/scattering method (the same applies hereinafter).

The pulverization method is not particularly limited, and the pulverization can be performed using a ball mill, an attritor, a bead mill, a jet mill, or the like.

In the case of wet pulverization, the mixed powder after pulverization is dried.

### <Preparation of Molded Body>

Next, a molded body is prepared using the raw material powder (mixed powder). That is, the raw material powder is molded.

The molding method is not particularly limited, and a general molding method can be used. For example, molding is performed using a hydrostatic press at a pressure of 100 MPa or more and 200 MPa or less.

As another method, a mixture obtained by adding an organic binder to the mixed powder may be molded into a predetermined shape by press molding, extrusion molding, sheet molding, or the like.

The shape obtained by molding is appropriately selected according to the use of the obtained sintered body.

### <Heating>

Next, the obtained molded body is heated. Accordingly, a sintered body is obtained.

From the viewpoint of improving the sinterability, a heating temperature (maximum temperature during heating) is preferably 1400° C. or higher, more preferably 1410° C. or higher, and still more preferably 1430° C. or higher.

On the other hand, when the heating temperature is too high, a part of the obtained sintered body may be melted and broken, or a sintered body having desired dimensions may not be obtained. Therefore, the heating temperature is preferably 1450° C. or lower, and more preferably 1440° C. or lower.

A heating time (holding time at the maximum temperature) is preferably 1 hour or longer, more preferably 2 hours or longer, and still more preferably 5 hours or longer.

On the other hand, the heating time is preferably 48 hours or shorter, more preferably 12 hours or shorter, and still more preferably 8 hours or shorter.

An atmosphere during heating (heating atmosphere) is not particularly limited, and examples thereof include: air atmosphere; inert atmosphere such as nitrogen or argon atmosphere; and reducing atmosphere such as hydrogen atmosphere or mixed atmosphere of hydrogen and nitrogen.

The obtained sintered body is preferably densified. The densification may be performed using, for example, a hot isostatic press.

Specifically, for example, a hot isostatic press is used to apply a pressure of 100 MPa or more and 200 MPa or less while heating at a temperature of 1000° C. or higher and 1350° C. or lower.

### EXAMPLES

Hereinafter, the present invention is specifically described with reference to Examples. However, the present invention is not limited to Examples described below.

Hereinafter, Examples 1 to 18 are Working Examples, and Examples 19 to 23 are Comparative Examples.

### Examples 1 to 23

Sintered bodies in each example were obtained in the following manner.

### <<Raw Material Powder>>

An electrically fused cordierite (2MgO·2Al₂O₃·5SiO₂) powder, a mullite (3Al₂O₃·2SiO₂) powder, and a magnesium oxide (MgO) powder were mixed. Optionally, powders of other metal oxides such as a yttrium oxide (Y₂O₃) powder and a silica (SiO₂) powder were also mixed.

As the electrically fused cordierite powder, a powder A and/or a powder B having a purity higher than that of the powder A were used.

As the powder A, “ELP-150FINE” manufactured by AGC Ceramics Co., Ltd. was used.

The powder B was prepared as follows. First, high purity magnesia (“KYOWAMAG MF30” manufactured by Kyowa Chemical Industry Co., Ltd.), high purity alumina (“AKP-30” manufactured by Sumitomo Chemical Co., Ltd.), and high purity silica (“ADMAFINE SO-E5” manufactured by ADMATECHS COMPANY LIMITED) were charged as raw materials into a crucible. Next, the raw materials in the crucible was melted by generating plasma using a carbon electrode. Thereafter, the molten raw material was air-pulverized and quenched to obtain the powder B.

As the mullite powder, “KM101” manufactured by KCM Corporation was used.

Specifically, the respective powders were mixed such that the contents of the elements in the element group M1 and the element M2 in the obtained sintered body were the values shown in Table 1 and Table 2 below to obtain raw material powders as mixed powders.

Each powder was subjected to magnetic separation before mixing. Specifically, a slurry in which each powder was dispersed in water was subjected to magnetic separation using a wet magnetic filter (“wet type high magnetic flux tester FG type” manufactured by NIPPON MAGNETIC DRESSING CO., LTD.).

As the magnetic separation conditions, a concentration of the slurry was 15 vol %, a magnetic flux density was 2.8 tesla, and the number of times of magnetic separation was 3 times, and the conditions were appropriately changed as necessary.

The raw material powders (mixed powders) were wet-mixed and pulverized using ethanol as a dispersion medium and using a ball mill having high purity alumina balls. The raw material powders after pulverization had a particle size (D₅₀) of 2.0 μm.

### <<Preparation of Molded Body and Heating

The obtained raw material powders (mixed powders) were pressurized at room temperature at a pressure of 180 MPa using a hydrostatic press to prepare a molded body.

Next, the prepared molded body was heated in the air atmosphere, to obtain a sintered body. The heating temperature was 1430° C. and the heating time was 5 hours.

Note that, the obtained sintered body was densified. Specifically, the obtained sintered body was heated at 1300° C. while being applied with a pressure of 145 MPa using a hot isostatic press.

### <Contents of Element Group M1 and Element M2>

Regarding the sintered body in each example, the contents of the elements in the element group M1 and the element M2 in terms of oxides were obtained by the method described above. The results are shown in Table 1 and Table 2 below.

The “other” elements in Table 1 and Table 2 below are Sr, P, Ga, Zr, Zn, and Nb.

### <Dielectric Loss Tangent and the Like>

Regarding the sintered body in each example, the porosity, the 4-point bending strength, the Weibull coefficient, the thermal conductivity, the heterogeneous phase amount, the dielectric loss tangent, and the relative dielectric constant were determined by the methods described above. The results are shown in Table 1 and Table 2 below. Note that, in the case of not being measured, “-” is shown in Table 1 and Table 2 below.

TABLE 1

| | | | Ex. 1 | Ex. 2 | Ex. 3 | Ex. 4 | Ex. 5 |
|---|---|---|---|---|---|---|---|
| M1 | SiO₂ | mass % | 47.919 | 49.887 | 50.825 | 47.883 | 47.819 |
| | MgO | mass % | 12.896 | 13.149 | 13.008 | 12.853 | 12.763 |
| | Al₂O₃ | mass % | 36.939 | 34.658 | 33.956 | 36.911 | 36.726 |
| | Y₂O₃ | mass % | 2.002 | 1.999 | 1.999 | 2.003 | 2.003 |
| | CaO | mass % | 0.121 | 0.166 | 0.116 | 0.123 | 0.126 |
| M2 | TiO₂ | mass % | 0.012 | 0.000 | 0.000 | 0.012 | 0.012 |
| | Fe₂O₃ | mass % | 0.048 | 0.078 | 0.051 | 0.062 | 0.092 |
| | NiO | mass % | 0.002 | 0.002 | 0.001 | 0.002 | 0.008 |
| | MnO | mass % | 0.002 | 0.002 | 0.000 | 0.002 | 0.006 |
| | Cr₂O₃ | mass % | 0.002 | 0.002 | 0.000 | 0.002 | 0.005 |
| | Na₂O | mass % | 0.036 | 0.038 | 0.032 | 0.083 | 0.205 |
| | K₂O | mass % | 0.008 | 0.007 | 0.000 | 0.008 | 0.093 |
| | La₂O₃ | mass % | 0.000 | 0.000 | 0.000 | 0.043 | 0.077 |
| | Others | mass % | 0.013 | 0.012 | 0.012 | 0.013 | 0.065 |
| | Fe₂O₃ + NiO + | mass % | 0.054 | 0.084 | 0.052 | 0.068 | 0.111 |
| | MnO + Cr₂O₃ | | | | | | |
| | Total M2 | mass % | 0.123 | 0.141 | 0.096 | 0.227 | 0.563 |
| Total M1 + M2 | | mass % | 100.000 | 100.000 | 100.000 | 100.000 | 100.000 |
| Porosity | | Vol % | 0.11 | 0.13 | 0.13 | 0.12 | 0.11 |
| 4-point bending strength | | MPa | 203 | 200 | 198 | 203 | 198 |
| Weibull coefficient | | — | 11.2 | 10.9 | 10.4 | 11.2 | 11.1 |
| Thermal conductivity | | W/(m · K) | 3.8 | 3.6 | 3.5 | 3.9 | 3.9 |
| Heterogeneous phase | | /cm² | 10 | 14 | 13 | 11 | 18 |
| amount | | | | | | | |
| Dielectric loss tangent (10 | | — | 0.00019 | — | — | — | — |
| GHz) | | | | | | | |
| Dielectric loss tangent (20 | | — | 0.00035 | 0.00041 | 0.00043 | 0.00039 | 0.00087 |
| GHz) | | | | | | | |
| Relative dielectric constant | | — | 4.92 | 4.89 | 4.87 | 4.92 | 4.92 |
| | | | Ex. 6 | Ex. 7 | Ex. 8 | Ex. 9 | Ex. 10 |
| M1 | SiO₂ | mass % | 47.992 | 47.981 | 47.493 | 50.134 | 47.832 |
| | MgO | mass % | 12.924 | 12.964 | 14.474 | 13.622 | 12.877 |
| | Al₂O₃ | mass % | 36.984 | 36.992 | 35.834 | 34.036 | 36.936 |
| | Y₂O₃ | mass % | 2.015 | 2.003 | 1.976 | 1.979 | 2.002 |
| | CaO | mass % | 0.005 | 0.005 | 0.132 | 0.128 | 0.124 |
| M2 | TiO₂ | mass % | 0.011 | 0.009 | 0.011 | 0.012 | 0.06 |
| | Fe₂O₃ | mass % | 0.029 | 0.015 | 0.049 | 0.048 | 0.108 |
| | NiO | mass % | 0.002 | 0.001 | 0.002 | 0.002 | 0.002 |
| | MnO | mass % | 0.002 | 0.000 | 0.000 | 0.000 | 0.002 |
| | Cr₂O₃ | mass % | 0.002 | 0.000 | 0.003 | 0.002 | 0.000 |
| | Na₂O | mass % | 0.027 | 0.023 | 0.008 | 0.017 | 0.037 |
| | K₂O | mass % | 0.000 | 0.000 | 0.006 | 0.008 | 0.008 |
| | La₂O₃ | mass % | 0.000 | 0.000 | 0.000 | 0.000 | 0.000 |
| | Others | mass % | 0.007 | 0.007 | 0.012 | 0.012 | 0.012 |
| | Fe₂O₃ + NiO + | mass % | 0.035 | 0.016 | 0.054 | 0.052 | 0.112 |
| | MnO + Cr₂O₃ | | | | | | |
| | Total M2 | mass % | 0.080 | 0.055 | 0.091 | 0.101 | 0.229 |

| | | | | | | |
|---|---|---|---|---|---|---|
| Total M1 + M2 | mass % | 100.000 | 100.000 | 100.000 | 100.000 | 100.000 |
| Porosity | Vol % | 0.11 | 0.11 | 0.12 | 0.12 | 0.14 |
| 4-point bending strength | MPa | 201 | 205 | 205 | 200 | 192 |
| Weibull coefficient | — | 11.2 | 12.6 | 11.0 | 11.1 | 10.4 |
| Thermal conductivity | W/(m · K) | 3.8 | 4.1 | 4.0 | 3.8 | 3.8 |
| Heterogeneous phase | /cm² | 9 | 7 | 12 | 11 | 78 |
| amount | | | | | | |
| Dielectric loss tangent (10 | — | 0.00022 | — | — | — | — |
| GHz) | | | | | | |
| Dielectric loss tangent (20 | — | 0.00033 | 0.00031 | 0.00039 | 0.00037 | 0.00094 |
| GHz) | | | | | | |
| Relative dielectric constant | — | 4.92 | 4.91 | 4.94 | 4.93 | 4.92 |

TABLE 2

| | | | Ex. 11 | Ex. 12 | Ex. 13 | Ex. 14 | Ex. 15 | Ex. 16 | Ex. 17 |
|---|---|---|---|---|---|---|---|---|---|
| M1 | SiO₂ | mass % | 47.717 | 47.745 | 48.607 | 48.102 | 47.688 | 47.395 | 46.435 |
| | MgO | mass % | 12.766 | 12.903 | 13.147 | 12.934 | 12.755 | 12.770 | 12.485 |
| | Al₂O₃ | mass % | 36.347 | 36.681 | 37.797 | 37.475 | 36.680 | 36.582 | 35.666 |
| | Y₂O₃ | mass % | 1.967 | 1.968 | 0.000 | 1.034 | 2.635 | 3.005 | 5.174 |
| | CaO | mass % | 1.056 | 0.560 | 0.104 | 0.106 | 0.103 | 0.108 | 0.111 |
| M2 | TiO₂ | mass % | 0.012 | 0.013 | 0.045 | 0.043 | 0.012 | 0.013 | 0.12 |
| | Fe₂O₃ | mass % | 0.062 | 0.061 | 0.048 | 0.054 | 0.055 | 0.057 | 0.053 |
| | NiO | mass % | 0.002 | 0.002 | 0.002 | 0.002 | 0.002 | 0.002 | 0.002 |
| | MnO | mass % | 0.002 | 0.002 | 0.002 | 0.002 | 0.002 | 0.002 | 0.002 |
| | Cr₂O₃ | mass % | 0.002 | 0.002 | 0.002 | 0.002 | 0.002 | 0.002 | 0.002 |
| | Na₂O | mass % | 0.045 | 0.041 | 0.132 | 0.137 | 0.045 | 0.042 | 0.048 |
| | K₂O | mass % | 0.008 | 0.009 | 0.008 | 0.008 | 0.009 | 0.009 | 0.009 |
| | La₂O₃ | mass % | 0.000 | 0.000 | 0.094 | 0.088 | 0.000 | 0.000 | 0.000 |
| | Others | mass % | 0.014 | 0.013 | 0.012 | 0.013 | 0.012 | 0.013 | 0.013 |
| | Fe₂O₃ + NiO + | mass % | 0.068 | 0.067 | 0.054 | 0.060 | 0.061 | 0.063 | 0.059 |
| | MnO + Cr₂O₃ | | | | | | | | |
| | Total M2 | mass % | 0.147 | 0.143 | 0.345 | 0.349 | 0.139 | 0.140 | 0.249 |

| | | | | | | | | |
|---|---|---|---|---|---|---|---|---|
| Total M1 + M2 | mass % | 100.000 | 100.000 | 100.000 | 100.000 | 100.000 | 100.000 | 100.120 |
| Porosity | Vol % | 0.16 | 0.15 | 0.11 | 0.11 | 0.12 | 0.09 | 0.11 |
| 4-point bending strength | MPa | 191 | 191 | 188 | 190 | 234 | 239 | 178 |
| Weibull coefficient | — | 10.6 | 10.5 | 11.6 | 11.2 | 11.2 | 12.1 | 12.6 |
| Thermal conductivity | W/(m · K) | 3.6 | 3.7 | 3.8 | 3.8 | 3.6 | 3.5 | 3.5 |
| Heterogeneous phase | /cm² | 15 | 14 | 9 | 10 | 10 | 11 | 10 |
| amount | | | | | | | | |
| Dielectric loss tangent (10 | — | — | — | — | — | — | — | — |
| GHz) | | | | | | | | |
| Dielectric loss tangent (20 | — | 0.00097 | 0.00066 | 0.00039 | 0.00039 | 0.00040 | 0.00040 | 0.00042 |
| GHz) | | | | | | | | |
| Relative dielectric constant | — | 4.92 | 4.92 | 4.91 | 4.91 | 4.92 | 4.93 | 4.92 |

| | | | Ex. 18 | Ex. 19 | Ex. 20 | Ex. 21 | Ex. 22 | Ex. 23 |
|---|---|---|---|---|---|---|---|---|
| M1 | SiO₂ | mass % | 48.487 | 47.387 | 46.711 | 53.122 | 44.335 | 44.899 |
| | MgO | mass % | 13.14 | 12.012 | 12.579 | 12.369 | 10.985 | 17.005 |
| | Al₂O₃ | mass % | 37.887 | 37.748 | 35.923 | 32.381 | 33.666 | 34.999 |
| | Y₂O₃ | mass % | 0.201 | 0.010 | 2.052 | 1.834 | 10.512 | 0.002 |
| | CaO | mass % | 0.100 | 2.203 | 0.139 | 0.116 | 0.102 | 0.102 |
| M2 | TiO₂ | mass % | 0.02 | 0.06 | 0.352 | 0.000 | 0.01 | 0.0567 |
| | Fe₂O₃ | mass % | 0.025 | 0.284 | 0.882 | 0.112 | 0.05 | 1.912 |
| | NiO | mass % | 0.002 | 0.002 | 0.002 | 0.002 | 0.002 | 0.045 |
| | MnO | mass % | 0.002 | 0.002 | 0.002 | 0.002 | 0.002 | 0.02 |
| | Cr₂O₃ | mass % | 0.002 | 0.000 | 0.053 | 0.002 | 0.002 | 0.052 |
| | Na₂O | mass % | 0.036 | 0.123 | 0.944 | 0.047 | 0.120 | 0.44 |
| | K₂O | mass % | 0.008 | 0.089 | 0.128 | 0.000 | 0.110 | 0.36 |
| | La₂O₃ | mass % | 0.080 | 0.000 | 0.153 | 0.000 | 0.094 | 0.094 |
| | Others | mass % | 0.01 | 0.080 | 0.080 | 0.013 | 0.01 | 0.014 |
| | Fe₂O₃ + NiO + | mass % | 0.031 | 0.288 | 0.939 | 0.118 | 0.056 | 2.029 |
| | MnO + Cr₂O₃ | | | | | | | |
| | Total M2 | mass % | 0.185 | 0.640 | 2.596 | 0.178 | 0.4 | 2.9937 |

| | | | | | | | |
|---|---|---|---|---|---|---|---|
| Total M1 + M2 | mass % | 100.000 | 100.000 | 100.000 | 100.000 | 100.000 | 100.000 |
| Porosity | Vol % | 0.11 | 0.17 | 0.22 | 0.21 | 0.09 | 0.21 |
| 4-point bending strength | MPa | 189 | 169 | 167 | 173 | 230 | 169 |
| Weibull coefficient | — | 11.6 | 9.8 | 10.1 | 9.4 | 12.1 | 9.4 |
| Thermal conductivity | W/(m · K) | 3.7 | 3.4 | 3.1 | 3.5 | 3.5 | 3.1 |
| Heterogeneous phase | /cm² | 9 | 105 | 175 | 18 | 10 | 108 |
| amount | | | | | | | |
| Dielectric loss tangent (10 | — | — | 0.00168 | 0.00267 | 0.00102 | 0.00110 | 0.00269 |
| GHz) | | | | | | | |
| Dielectric loss tangent (20 | — | 0.00040 | 0.00215 | 0.00327 | 0.00122 | 0.00120 | 0.00435 |
| GHz) | | | | | | | |
| Relative dielectric constant | — | 4.91 | 4.90 | 4.89 | 4.83 | 4.81 | 4.98 |

### <Conclusion of Evaluation Results>

As shown in Table 1 and Table 2 above, the sintered bodies in Examples 1 to 18 have a dielectric loss tangent at 20 GHz of 0.00100 or less.

In contrast, in Example 19 in which the content of Ca (in terms of oxides) is more than 2.0 mass %, the dielectric loss tangent at 20 GHz is more than 0.00100.

In addition, in Example 20 in which the content of the element M2 (in terms of oxides) is more than 2.5 mass %, the dielectric loss tangent at 20 GHz is more than 0.00100.

In addition, in Example 21 in which the content of Si (in terms of oxides) is more than 53.0 mass %, the dielectric loss tangent at 20 GHz is more than 0.00100.

In addition, in Example 22 in which the content of yttrium (in terms of oxides) is more than 7.0 mass %, the dielectric loss tangent at 20 GHz is more than 0.00100.

In addition, in Example 23 in which the content of the element M2 (in terms of oxides) is more than 2.5 mass %, the dielectric loss tangent at 20 GHz is more than 0.00100.

Note that, as described above, the dielectric loss tangent decreases as the frequency decreases. That is, the dielectric loss tangent at 10 GHz is smaller than the dielectric loss tangent at 20 GHz.

Therefore, in all of Examples 1 to 18, since the dielectric loss tangent at 20 GHz is 0.00100 or less, it can be estimated that the dielectric loss tangent at 10 GHz is 0.00100 or less.

### INDUSTRIAL APPLICABILITY

According to the present invention, a novel cordierite sintered body and a method for producing the same can be provided.

Although the present invention has been described in detail with reference to specific embodiments, it is apparent to those skilled in the art that various changes and modifications can be made without departing from the spirit and scope of the present invention.

The present application is based on a Japanese Patent Application (Japanese Patent Application No. 2023-117542) filed on Jul. 19, 2023, the contents of which are incorporated herein by reference.

1. A cordierite sintered body comprising at least calcium, magnesium, aluminum, and silicon among elements belonging to an element group M1 consisting of calcium, magnesium, aluminum, yttrium, and silicon, wherein
a content of silicon is 44.0 mass % or more and 53.0 mass % or less in terms of oxides,
a content of calcium is 2.0 mass % or less in terms of oxides,
a content of yttrium is 7.0 mass % or less in terms of oxides,
a content of an element M2 including a metal element other than the elements belonging to the element group M1 is 2.5 mass % or less in terms of oxides, and
a dielectric loss tangent at 20 GHz is 0.00100 or less.

2. The cordierite sintered body according to claim 1, wherein a content of magnesium is 15.0 mass % or less in terms of oxides.

3. The cordierite sintered body according to claim 1, having a Weibull coefficient of 9.0 or more.

4. The cordierite sintered body according to claim 1, wherein a content of iron is 2000 ppm by mass or less in terms of oxides.

5. The cordierite sintered body according to claim 1, wherein the content of calcium is 1.0 mass % or less in terms of oxides.

6. The cordierite sintered body according to claim 1, wherein a content of aluminum is 33.0 mass % or more in terms of oxides.

7. The cordierite sintered body according to claim 1, having a relative dielectric constant at 20 GHz of 4.80 or more.

8. The cordierite sintered body according to claim 1, wherein a total content of sodium, potassium, strontium, titanium, phosphorus, chromium, manganese, iron, nickel, lanthanum, gallium, zirconium, zinc, and niobium is 3000 ppm by mass or less in terms of oxides.

9. The cordierite sintered body according to claim 1, wherein a total content of chromium, manganese, iron, and nickel is 1000 ppm by mass or less in terms of oxides.

10. The cordierite sintered body according to claim 1, having a thermal conductivity of 3.0 W/(m·K) or more.

11. The cordierite sintered body according to claim 1, wherein a number of foreign particles containing the element M2 and having an equivalent circle diameter of 5 μm or more is 150/cm² or less.

12. The cordierite sintered body according to claim 1, wherein the content of yttrium is 0.2 mass % or more in terms of oxides.

13. The cordierite sintered body according to claim 1, having a 4-point bending strength of 170 MPa or more.

14. A method for producing the cordierite sintered body according to claim 1, the method comprising:
preparing a molded body using a raw material powder, and
heating the molded body, wherein
as the raw material powder, a mixed powder containing a cordierite powder produced by an electric fusion method, a mullite powder, and a magnesium oxide powder is used.

15. The method for producing the cordierite sintered body according to claim 14, wherein the cordierite powder is subjected to magnetic separation before use.
